(19) United States
(12) Patent Application Publication
(10) Pub. No.: US 2012/0317637 A1
(43) Pub. Date: Dec. 13, 2012

(54) COMMUNICATION BETWEEN PRIVATE NETWORK AND PUBLIC NETWORK

(76) Inventor: Zhe Huang, Beijing (CN)

(21) Appl. No.: 13/489,982

(22) Filed: Jun. 6, 2012

(30) Foreign Application Priority Data
Jun. 8, 2011 (CN) 201110152879.8

(51) Int. Cl. G06F 21/00

(52) U.S. Cl. 726/12

(57) ABSTRACT

A first device in a private network is assigned a public network address that is shared in the private network, and a port number range that uniquely identifies the first device in the private network. The first device sends a network device an outgoing packet which is intended for a second device in the public network. The outgoing packet includes the assigned public network address as a source network address, a port number within the assigned port number range as a source port number, and a public network address of the second device as a destination network address. The packet is transmitted by the network device to the second device, according to the destination network address.

### BACKGROUND

Network address translation (NAT) generally refers to mapping or translation of Internet Protocol (IP) addresses of one address realm to another to allow devices in one network to communicate with devices on a different network. For example, in a home local area network (LAN), NAT is used for mapping a number of private IP addresses to a single public IP address supplied by an Internet Service Provider (ISP). This allows computers on the LAN to share a single Internet connection, and helps slow down the exhaustion of public IP addresses. If an application layer of an incoming or outgoing packet contains address information, then application layer gateway (ALG) processing is also required to translate private network addresses in the application layer into public network addresses.

### BRIEF DESCRIPTION OF DRAWINGS

By way of non-limiting example(s), a method, network device and computer program product for communication between a private network and a public network will be described with reference to the following drawings, in which:

FIG. 1 is a schematic diagram of an example network for communication between private network and public network;

FIG. 2 is a flowchart of an example method for communication between private network and public network;

FIG. 3 is a flowchart of an example method for configuring a first device in the network in FIG. 1;

FIG. 4 is a message flow diagram for communication between a first device (host A), network device and server in FIG. 1;

FIG. 5 is a message flow diagram for communication between another first device (host B), network device and server in FIG. 1; and

FIG. 6 is a block diagram of an example structure of a device capable of acting as a network device or first device.

### DETAILED DESCRIPTION

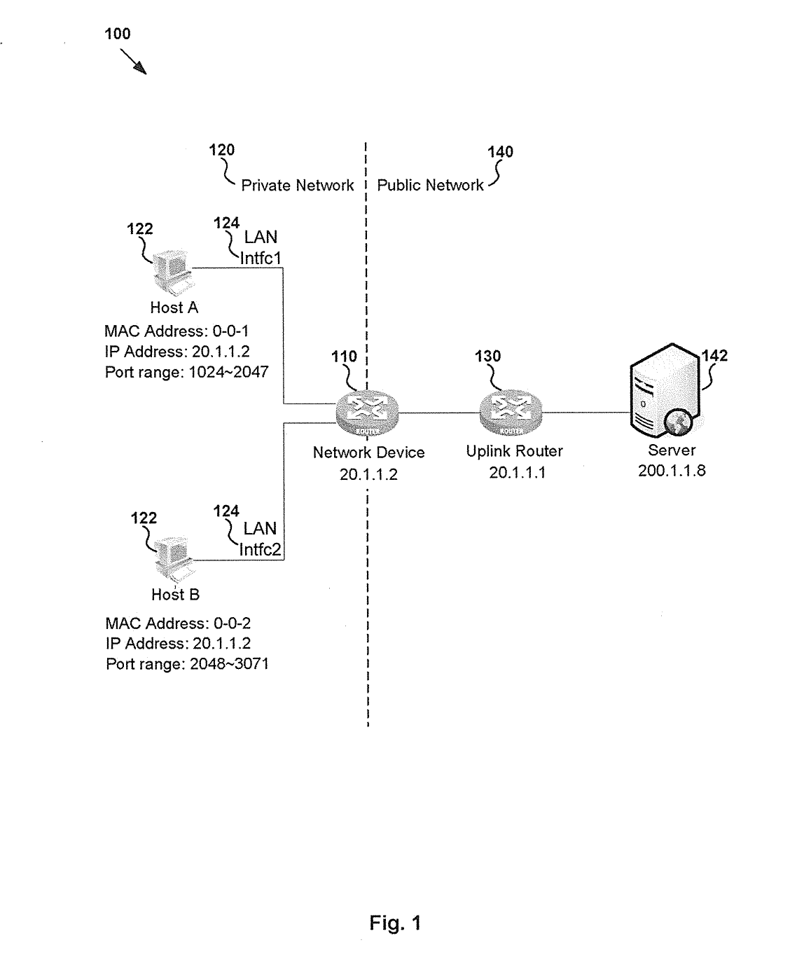

FIG. 1 shows an example communications network 100 in which a network device 110 is provided for communication between first devices 122 in a private network 120, and second devices 142 (one shown for simplicity) in a public network 140. The network device 110 may be referred as a network address translation (NAT) device.

The public network 140 may be a wide area network (WAN) such as the Internet and the private network 120 a local area network (LAN) etc. The public network 140 has an address realm with unique network addresses assigned by an address registry, such as the Internet Assigned Numbers Authority (LANA) etc. The private network 120 has a private address realm that is independent of the address realm of the public network.

In the example in FIG. 1, the first devices 122 are hosts A and B and the second device 142 is a server, which may be an application server, web server, or mail servers etc. The network device 110 has multiple LAN interfaces 124, such as LAN Intfc1 and LAN Intfc2. For example, host A is connected to the network device 110 via LAN Intfc1 and host B is connected to the network device 110 via LAN Intfc2. The network device 110 connects hosts A and B to a server 142 on the public network 140 via an uplink router 130.

The network device 110 may be any device with suitable processing capabilities, such as a router, switch or bridge etc. Although one uplink router 140 and one server 150 are shown in FIG. 1, any number of routers and servers may be distributed throughout the public network 140.

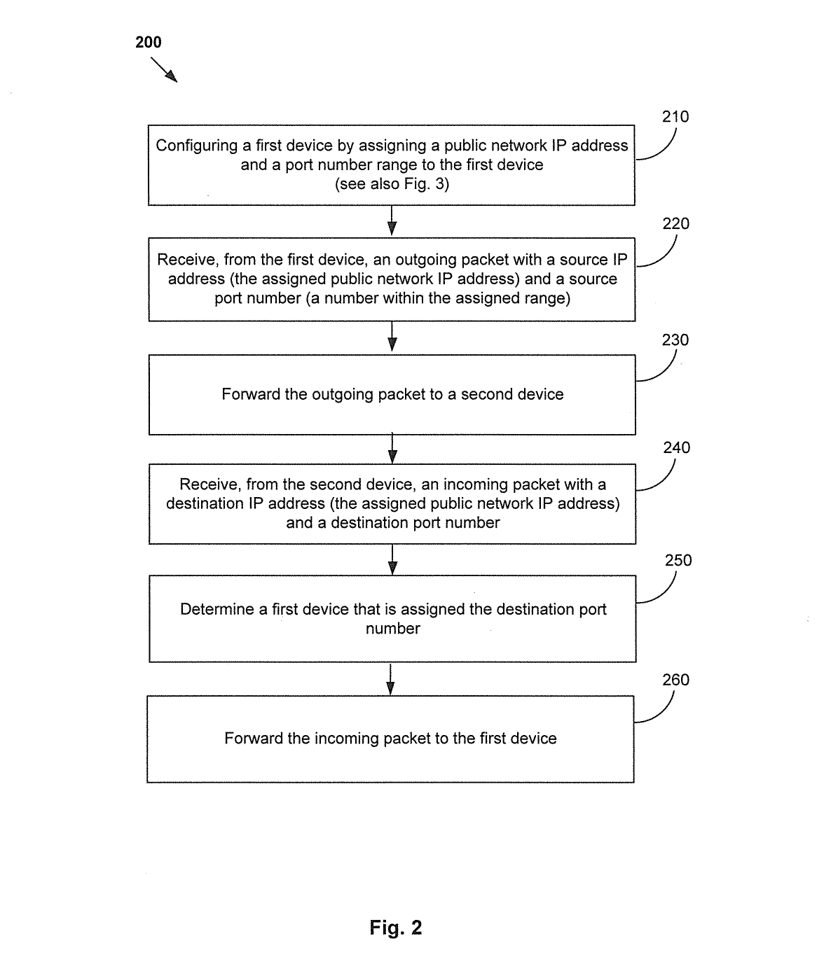

Referring also to FIG. 2, an example method for communication between the private network 120 and public network 140 is shown, in which the following are performed:

Configuration of First Devices (See Block 210):
The network device 110 configures a first device 122 in the private network 120 by assigning the first device 122 with, inter alia, a public network IP address and a port number range that uniquely identifies the first device 122 in the private network 120.

Transmission of Outgoing Packets (See Blocks 220 and 230):
The network device 110 processes any outgoing packets from the first device 122 that are intended for a second device 142 in the public network 140. The first device 122 uses the assigned public network IP address as a source IP address and a port number within the assigned range as a source port number in its communication with the second device 142.

Transmission of Incoming Packets (See Blocks 240, 250 and 260):
The network device 110 processes incoming packets from the second device 142 in the public network 140. The second device 142 uses the assigned public network IP address as a destination IP address and the port number within the assigned range as a destination port number in its communication with the first device 142.

According to the example method in FIG. 2, the first device 122 communicates with the public network 140 using the assigned public network IP address and port number range that uniquely identifies each first device 122 in the private network 120. To minimise public network IP address consumption, the same public network IP address is shared among the first devices 122 in the private network 120.

According to the example method in FIG. 2, the network device 110 does not have to perform any network address translation and port translation when forwarding packets to and from the first device 122. Application layer gateway (ALG) processing, which requires translation of network addresses in the application layer into public network addresses, is also not required. Advantageously, this reduces CPU consumption at the network device 110 while maintaining end-to-end characteristics of an IP network.

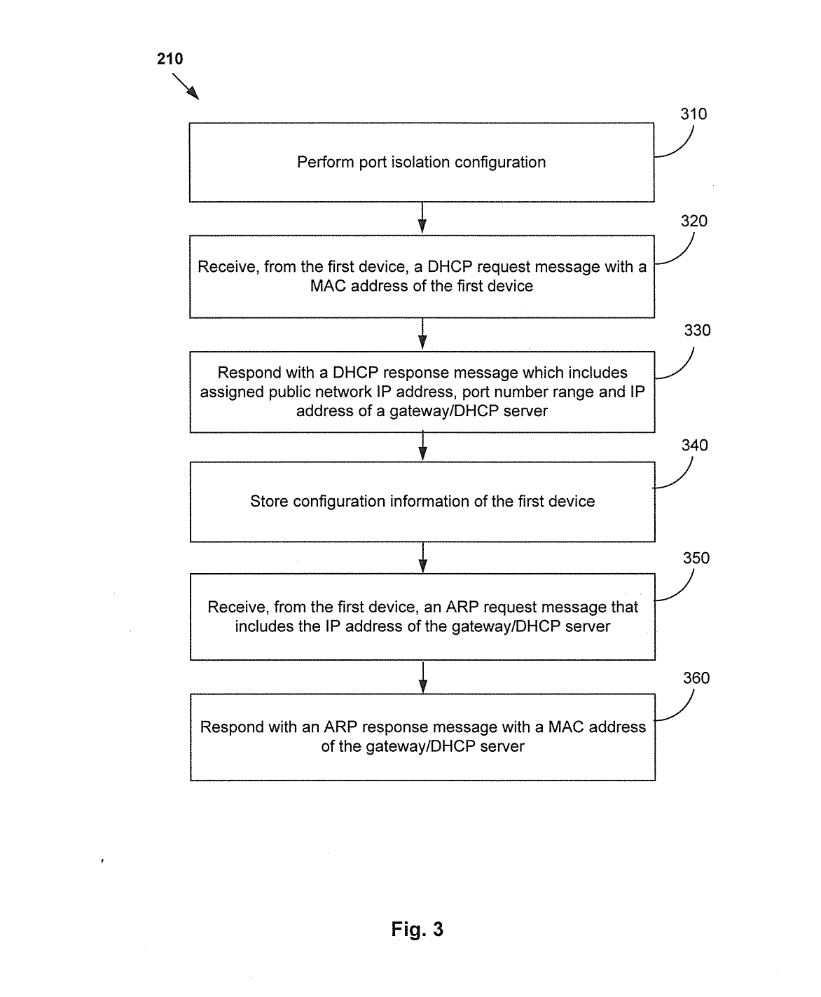

Non-limiting examples of the method performed by the network device 110 in FIG. 2 will now be described in further detail with reference to FIGS. 3, 4 and 5.

### Configuration of First Devices

FIG. 3 shows an example method for configuring the first devices 122 in the private network 120.

### (a) Port Isolation Configuration

If the network device 110 has multiple local area network (LAN) interfaces (e.g. in FIG. 1), port isolation is performed to isolate the Layer 2 (link layer) traffic of first devices 122 on the interfaces; see block 310. Following port isolation in the example in FIG. 1, host A and host B accesses the public network 140, and exchange Layer 2 traffic with each other, via the network device 110.

If the private network is a small private network 120, such as a home network, communication between hosts 122 is generally minimal, and the main traffic in the network 120 is to access Transmission Control Protocol (TCP) or User Datagram Protocol (UDP) applications, such as web applications and Simple Mail Transfer Protocol (SMTP).

### (b) DHCP Configuration

In one example, dynamic host configuration protocol (DHCP) is used by the first devices 122 for requesting configuration, and by the network device 110 for delivering configuration information to the first devices 122.

At block 320 in FIG. 3, the network device 110 receives a DHCP request message from a first device 122 via a LAN interface 124. The DHCP request message includes a MAC address of the first device 122.

In response to the DHCP request message, the network device 110 assigns a public network IP address and a port number range to the first device 122. To minimise public network IP address consumption, a common public network IP address is assigned to the first devices 122 in the private network 120. The port number range, however, uniquely identifies the first device 122 in the private network 120.

A port is generally associated with an IP address of the host as well as the type of protocol used for communication, such as TCP and UDP. A port is identified by a port number, which is generally a 16-bit number. The minimum size of the port number range is one (in which case a single port number is assigned).

Further, the network device 110 assigns the first device 122 an IP address of a DHCP server and an IP address of a gateway of the first device 122. The IP addresses should be different to the public network IP address assigned for communication with the public network 140.

In one example, the public network IP address of the uplink router 130 is used as the IP addresses of the DHCP server and gateway. In another example, a second public network IP address (which is different to the assigned public network IP address) is configured on the network device 110 and used as the IP addresses of the DHCP server and gateway.

At block 330 in FIG. 3, the network device 110 sends the first device 122 a DHCP response message that includes: the public network IP address; port number range; and IP addresses of the DHCP server and gateway of the first device 122. The assigned port number range may be carried in an extension field of the DHCP response message. The field may be in a Type-Length-Value (TLV) format.

At block 340 in FIG. 3, the network device 110 stores the following configuration information of the first device 122: the assigned public network IP address, the assigned port number range, an identifier of the LAN interface between the first device 122 and the network device 110, the MAC address of the first device 122 and a lease duration.

In the example in FIG. 1, the public network IP address of network device 110 is 20.1.1.2; the public network IP address of the uplink router 130 is 20.1.1.1; and the MAC addresses of host A and host B are 0-0-1 and 0-0-2 respectively.

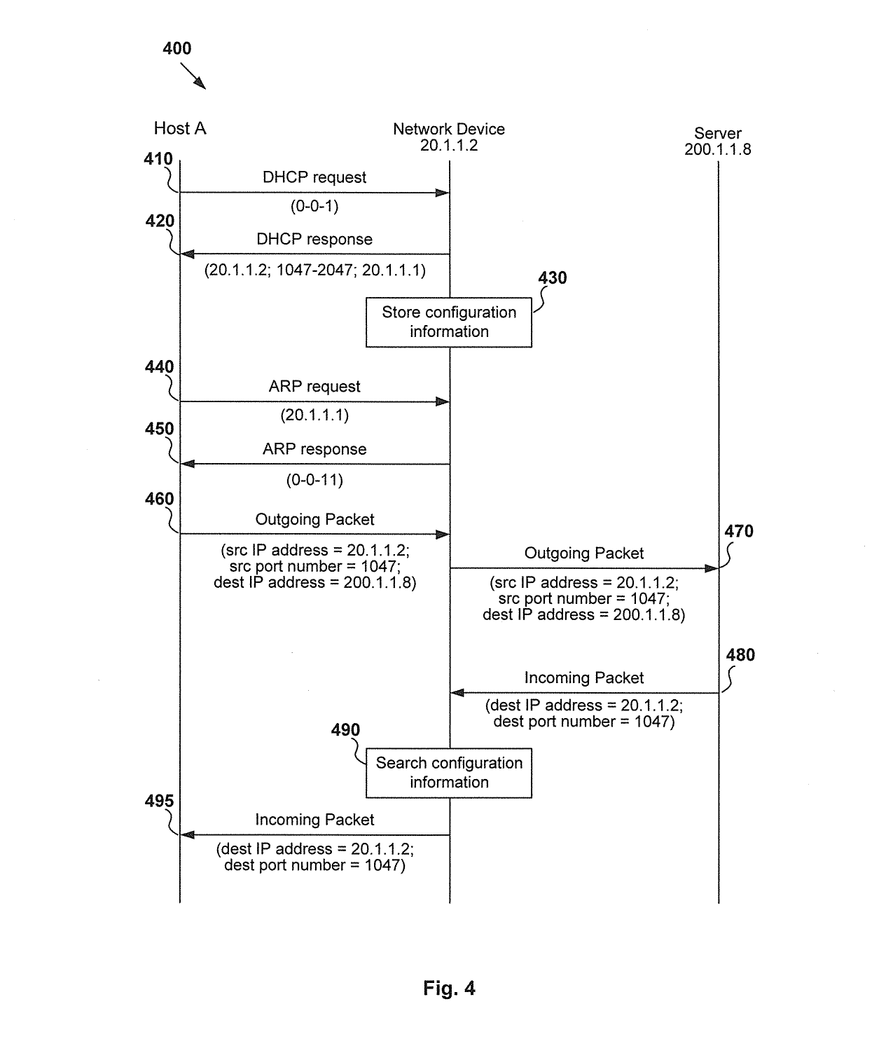

Referring also to FIG. 4, the network device 110 receives a DHCP request message from host A via LAN Intfc1, where the DHCP request message includes the MAC address of host A (0-0-1); see 410.

In response, the network device 110 assigns configuration information to host A, and returns a DHCP response message with the following parameters; see also 420:

(i) a public network address (e.g. 20.1.1.2, which is the IP address of network device 110);
(ii) a port number range (e.g. 1024-2047);
(iii) an IP addresses of a DHCP sever and a gateway (e.g. 20.1.1.1, which is the IP address of the uplink router 130).

The network device 110 then stores the configuration information; see also 430. In one example, the configuration information may be stored is the form of an entry in a DHCP lease table, as follows:

TABLE 1
Configuration information of Host A

| | Port number | MAC | LAN interface | Lease |
|---|---|---|---|---|
| IP address | range | address | identifier | duration |
| 20.1.1.2 | 1024-2047 | 0-0-1 | LAN INTFC1 | 24 hours |

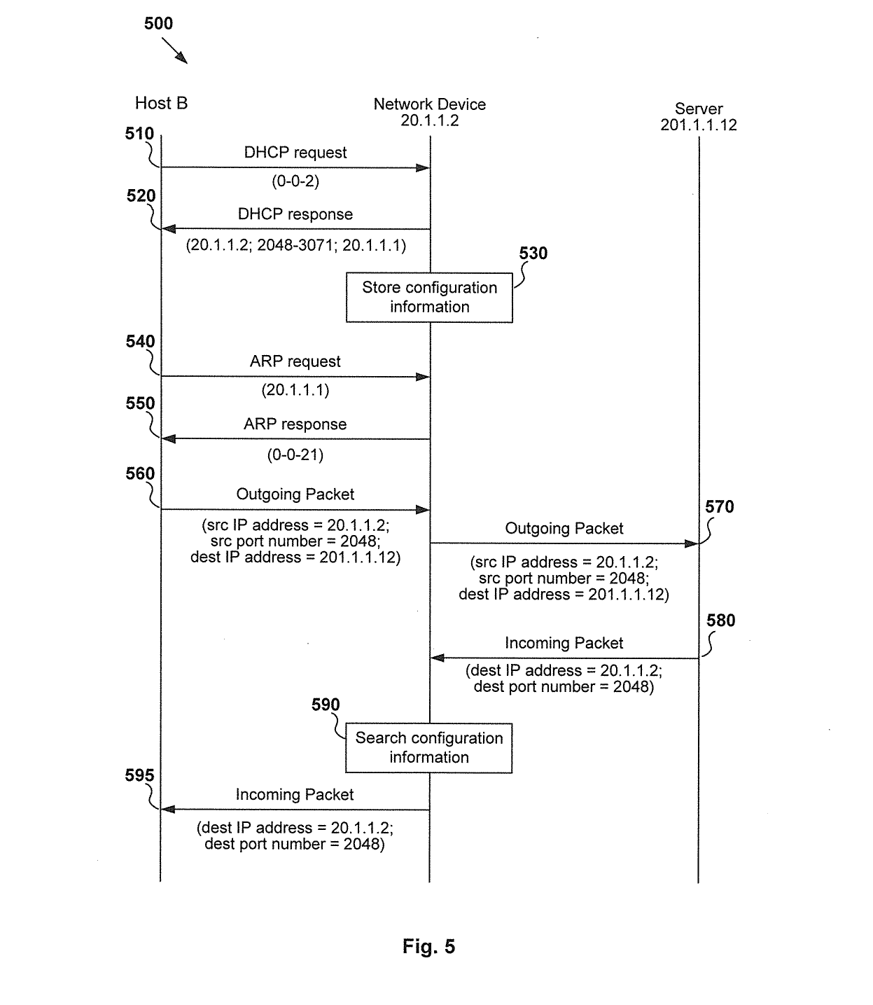

Configuration information of host B may be assigned in a similar manner. Referring now to FIG. 5, the network device 110 receives a DHCP request message from host B via LAN Intfc2. The DHCP request message includes the MAC address of host B (0-0-2); see 510.

In response, the network device 110 assigns configuration information to host B, and returns a DHCP response message with the following parameters; see also 520:

(i) a public network address (e.g. 20.1.1.2, which is the IP address of network device 110);
(ii) a port number range (e.g. 2048-3071);
(iii) an IP addresses of a DHCP sever and a gateway (e.g. 20.1.1.1, which is the IP address of the uplink router 130).

The network device 110 then stores the configuration information of host B as follows; see also 530:

TABLE 1
Configuration information of Host B

| | Port number | MAC | LAN interface | Lease |
|---|---|---|---|---|
| IP address | range | address | identifier | duration |
| 20.1.1.2 | 2048-3071 | 0-0-2 | LAN INTFC2 | 24 hours |

In the examples in FIG. 4 and FIG. 5, host A and host B share a common public network IP address (20.1.1.2) but have non-overlapping port number range, that is 1024-2047 and 2048-3071 respectively. As such, the assigned port number range uniquely identifies the host (A or B) in the private network 120.

### (c) Address Resolution Protocol (ARP) Configuration

The network device 110 also serves as a proxy for address resolution protocol (ARP) to resolve network layer IP addresses of the DHCP server and the gateway into link layer MAC addresses.

At block 350 in FIG. 3, the network device 110 receives an ARP request message that includes an IP address to be resolved from the first device 122 via a LAN interface 124. In response, at block 360 in FIG. 3, the network device 110 sends the first device 122 an ARP response message that includes a MAC address for the IP address in the ARP request message.

In one example, the IP address of the DHCP server is the same as the IP address of the gateway, in which case the first device 122 only needs to send one ARP request message to the network device 110. In this case, only one ARP request is required because the MAC address of the DHCP server is the same as that of the gateway. A virtual MAC address of a LAN interface 124 of the network device 110 may be used as the MAC address of the DHCP server and gateway of the first device 110.

For example in FIG. 4, upon receiving an ARP request message with IP address 20.1.1.1 from host A, the network device 110 responds with an ARP response with MAC address 0-0-11; see 440 and 450. Similarly, in FIG. 5, upon receiving an ARP request message with IP address 20.1.1.1 from host B, the network device 110 responds with an ARP response with MAC address 0-0-21; see 540 and 550.

When the first device 122 sends a DHCP message, the MAC address of the DHCP server will be used as a destination MAC address. When the first device 110 sends a packet (e.g. TCP or UDP) to the public network 140, the MAC address of the gateway will be used as a destination MAC address. This way, the network device 110 will receive any subsequent DHCP messages and packets sent by the first device 122.

### Outgoing Packet Transmission

Following configuration according to block 210 in FIG. 2, the first devices 122 can communicate with a second device 142 in the public network 140 using the assigned public network IP address and port number range. This allows the network device 110 to forward any traffic to and from the first devices 122 without requiring any network address or port translation.

More specifically, at block 220 in FIG. 2, the network device 110 receives an outgoing packet from the first device 122. The packet may be a TCP or UDP packet, and carries the following packet header information:
source IP address, which is the assigned public network IP address; and
source port number, which is a number within the assigned port number range.

Other information carried by the packet includes:
source MAC address, which is the MAC address of the host;
destination IP address, which is the IP address of the second device 142 in the public network 140; and
destination MAC address, which is the MAC address of the gateway assigned during the ARP configuration;

Upon receiving the packet from the first device 122, the network device 110 can forward the packet to the server 142 via the uplink router 130; see 230. The packet is forwarded without having to modify the source IP address and source port number of the packet.

In the example in FIG. 4, host A sends a packet with a source IP address (20.1.1.2), source port number (1047), and destination IP address (200.1.1.8) of the server 142 in the public network 140; see 460. Upon receiving the packet, the network device 110 forwards the packet to the server 142 according to its destination IP address (200.1.1.8) via the uplink router 130; see 470.

Similarly, in the example in FIG. 5, host B sends a packet with a source IP address (20.1.1.2), source port number (2048), and destination IP address (200.1.1.8) of the server 142 in the public network 140; see 560. Upon receiving the packet, the network device 110 simply forwards the packet to the server 142 via the uplink router 130; see 570.

Since the source IP address (20.1.1.2) of the packet is already a public network IP address and the port number (1047 or 2048) unique identifies the host (A or B), the network device 110 does not have to perform any address and port number translation.

### Incoming Packet Transmission

At block 240, the network device 110 receives an incoming packet from the second device 142 in the public network 140 that is intended for a first device 122 in the private network 120.

The incoming packet carries a destination IP address (the public network IP address assigned by the network device 110 to the first device 122) and a destination port number.

Based on the destination port number, the network device 110 determines whether a first device 122 in the private network 120 is assigned with the destination port number; see block 250. If the determination is affirmative, the incoming packet is forwarded to the first device 122 without requiring any address and port translation; see block 260.

In particular, the network device 110 searches the configuration information to determine whether the destination port number is within a port number range assigned to a first device 122. If yes, the packet is forwarded to the first device based on its MAC address and LAN interface identifier in the configuration information.

In the example in FIG. 4, the network device 110 receives an incoming packet from the server 142 via the uplink router 130; see 480. Based on the destination IP address (20.1.1.2) and destination port number (1024) of the packet, the network device 110 searches the configuration information in Table 1 to determine whether a host has been assigned with the destination port number (1024); see 490.

In this case, host A is identified as the intended recipient because the destination port number (1024) is within its assigned port number range (1024-2047). As such, the network device 110 forwards the packet to host A according to the LAN interface (LAN INTFC1) and MAC address (0-0-1) of host A; see 495.

Similarly, in the example in FIG. 5, the network device 110 receives another incoming packet from the server 142 via the uplink router 130; see 580. Based on the destination IP address (20.1.1.2) and destination port number (2048) of the packet, the network device 110 searches the configuration information in Table 2 to determine whether a host has been assigned with the destination port number (2048); see 590.

In this case, host B is identified as the intended recipient because the destination port number (2048) is within its assigned port number range (2048-3071). Accordingly, the network device 110 forwards the packet to host B according to the LAN interface (LAN INTFC2) and MAC address (0-0-2) of host B; see 595.

### Device 600

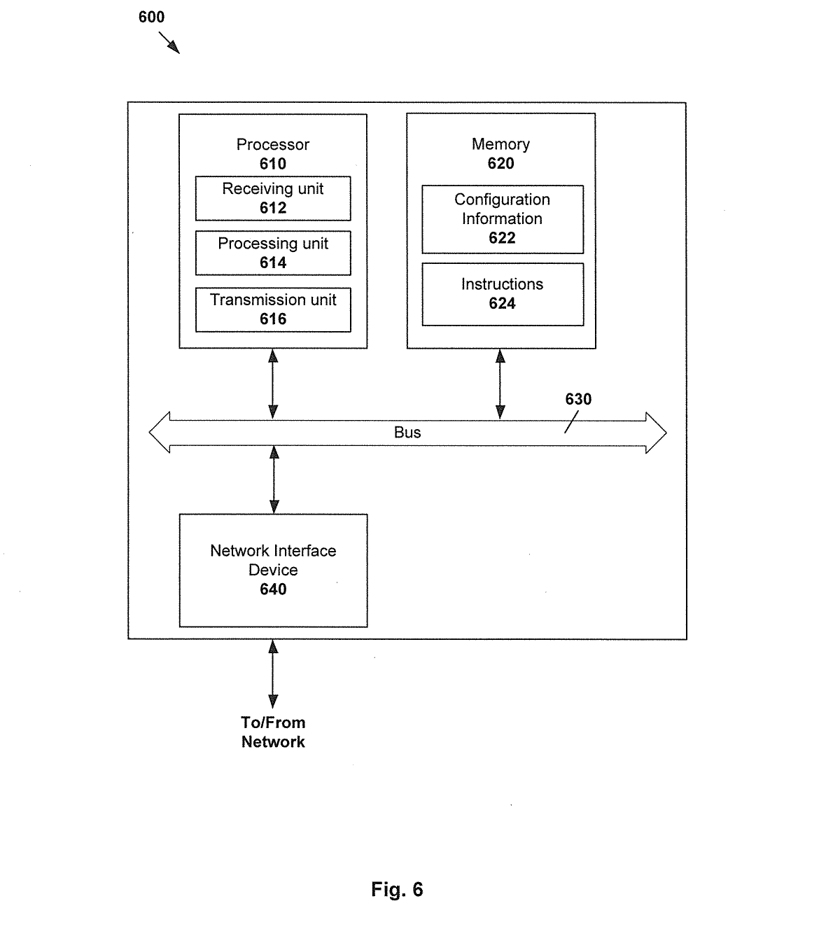

The above examples can be implemented by hardware, software or firmware or a combination thereof. Referring to FIG. 6, an example structure of a device 600 capable of acting as a network device 110 or first device 122 in the network 100 is shown. The example device 600 includes a processor 610, a memory 620 and a network interface device 630 that communicate with each other via a bus 640.

The processor 610 implements functional units in the form of a receiving unit 612, a processing unit 614, and a transmission unit 616. Information may be transmitted and received via the network interface device 630, which may include one or more logical or physical ports that connect the device 600 to another network device.

In case of a device 600 capable of acting as a “network device” 110:
The processing unit 614 is to configure a first device 122 in the private network 120 to assign the first device 122 with a public network address 140 that is shared in the private network 120, and a port number range that uniquely identifies the first device in the private network 120.
The processing unit 614 is to store configuration information 622 of the first device 122 in the memory 620, such as in the form of the DHCP lease information in Table 1 and Table 2. The configuration information is accessible by the processor 610 when processing packets according to blocks 240, 250 and 260 in FIG. 2.
The receiving unit 612 is to receive, from the first device 122, an outgoing packet intended for a second device 142 in the public network 140. The outgoing packet includes: the assigned public network address as a source network address; a port number within the assigned port number range as a source port number; a public network address of the second device 142 as a destination network address.
The transmitting unit 616 is to transmit, to the second device 142, the packet according to the destination network address.

In case of a device capable of acting as a “first device” 122:
The processing unit 614 is to request configuration by a network device 110 in the private network 120.
The receiving unit 612 is to receive, from the network device 110, configuration information that includes a public network address and a port number range assigned by the network device 110. The public network address is shared with at least one other device in the private network, but the port number range uniquely identifies the first device in the private network.
The processing unit is to store the received configuration information 622 in the memory 620.
The transmitting unit 616 is to transmit, to the network device 110, an outgoing packet intended for a second device 142 in the public network 140. The outgoing packet includes: the assigned public network address as a source network address; a port number within the assigned port number range as a source port number; a public network address of the second device 142 as a destination network address.

For example, the various methods, processes and functional units described herein may be implemented by the processor 610. The term ‘processor’ is to be interpreted broadly to include a CPU, processing unit, ASIC, logic unit, or programmable gate array etc. The processes, methods and functional units may all be performed by a single processor 610 or split between several processors (not shown in FIG. 6 for simplicity); reference in this disclosure or the claims to a ‘processor’ should thus be interpreted to mean ‘one or more processors’.

Although one network interface device 630 is shown in FIG. 6, processes performed by the network interface device 630 may be split between several network interface devices. As such, reference in this disclosure to a ‘network interface device’ should be interpreted to mean ‘one or more network interface devices”.

The processes, methods and functional units may be implemented as machine-readable instructions executable by one or more processors, hardware logic circuitry of the one or more processors or a combination thereof. In the example in FIG. 6, the machine-readable instructions 624 are stored in the memory 620.

Further, the processes, methods and functional units described in this disclosure may be implemented in the form of a computer program product. The computer program product is stored in a computer-readable storage medium and comprises a plurality of computer-readable instructions for making a device 600 (which can be a personal computer, a server or a network device such as a router, switch, bridge, host, access point etc.) implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

It will be appreciated that numerous variations and/or modifications may be made to the processes, methods and functional units as shown in the examples without departing from the scope of the disclosure as broadly described. The examples are, therefore, to be considered in all respects as illustrative and not restrictive.

1. A method for communication between a private network and a public network, the method being implemented by a network device and comprising:
configuring a first device in the private network to assign the first device with a public network address that is shared in the private network, and a port number range that uniquely identifies the first device in the private network;
receiving, from the first device, an outgoing packet intended for a second device in the public network, wherein the outgoing packet includes: the assigned public network address as a source network address; a port number within the assigned port number range as a source port number; a public network address of the second device as a destination network address; and
transmitting, to the second device, the packet according to the destination network address.

2. The method of claim 1, wherein configuring the first device further comprises:
receiving, from the first device, a dynamic host configuration protocol (DHCP) request message that includes a medium access control (MAC) address of the first device;
assigning the first device with a public network address of a gateway of the first device; and
transmitting, to the first device, a dynamic host configuration protocol (DHCP) response message that includes the assigned public network address, port number range, and public network address of the gateway.

3. The method of claim 2, wherein a public network address of an uplink router of the network device is assigned as the public network address of the gateway.

4. The method of claim 3, wherein configuring the first device further comprises:
receiving, from the first device, an address resolution protocol (ARP) request message that includes the public network address of the gateway;
determining a medium access control (MAC) address of the gateway for the public network address of the gateway; and
transmitting, to the first device, an address resolution protocol (ARP) response message that includes the medium access control (MAC) address of the gateway.

5. The method of claim 4, wherein the outgoing packet includes the medium access control (MAC) address of the gateway as a destination medium access control (MAC) address; and the outgoing packet is transmitted based on the destination medium access control (MAC) address.

7. The method of claim 1, wherein configuring the first device further comprises:
storing configuration information of the first device, the configuration information including the assigned public network address; the assigned port number range; an identifier of a local area network (LAN) interface connecting the first device to the network device; and a medium access control (MAC) address of the first device.

8. The method of claim 7, wherein the method further comprises:
receiving, from the second device, an incoming packet intended for the first device in the private network, wherein the packet includes: the assigned public network address as a destination network address, and a destination port number;
based on the configuration information, determining whether the destination port number is within an assigned port number range that uniquely identifies a first device in the private network;
if determination is affirmative, transmitting the packet to the first device according to the identifier of a local area network (LAN) interface and the medium access control (MAC) address of the first device.

9. The method of claim 1, wherein:
the network device comprises multiple local area network (LAN) interfaces each connected to one or more first devices; and
configuring each first device further comprises performing port isolation on the local area network (LAN) interface connecting the first device to the network device such that any outgoing packet or dynamic host configuration protocol (DHCP) message, or both, from the first device are received by the network device.

10. A device for communication between a private network and a public network, the device being capable of acting as a network device in the private network and comprising a processor to:
configure a first device in the private network by assigning the first device with a public network address that is shared in the private network, and a port number range that uniquely identifies the first device in the private network;
receive, from the first device, an outgoing packet intended for a second device in the public network, wherein the outgoing packet includes: the assigned public network address as a source network address; a port number within the assigned port number range as a source port number; a public network address of the second device as a destination network address; and
transmit, to the second device, the packet according to the destination network address.

11. A computer program product for communication between a private network and a public network, the computer program product comprising a non-transitory computer readable storage medium storing machine readable instructions which are executable by a processor of a network device, the machine-readable instructions comprising instructions to the processor to:
configure a first device in the private network by assigning the first device with a public network address that is shared in the private network, and a port number range that uniquely identifies the first device in the private network;
receive, from the first device, an outgoing packet intended for a second device in the public network, wherein the outgoing packet includes: the assigned public network address as a source network address; a port number within the assigned port number range as a source port number; a public network address of the second device as a destination network address; and
transmit, to the second device, the packet according to the destination network address.

12. A device for communication between a private network and a public network, the device being capable of acting as a first device in the private network and comprising a processor to:
request, from a network device in the private network, configuration information for communication with the public network;
receive, from the network device, configuration information that includes a public network address that is shared with at least one other first device in the private network, and a port number range that uniquely identifies the first device in the private network; and
transmit, to the network device, an outgoing packet intended for a second device in the public network, wherein the outgoing packet includes: the assigned public network address as a source network address; a port number within the assigned port number range as a source port number; a public network address of the second device as a destination network address.
